(19) United States
(12) Patent Application Publication
(10) Pub. No.: US 2005/0062253 A1
(43) Pub. Date: Mar. 24, 2005

(54) Occupant driven mobile device

(76) Inventor: Michael Osher, Afula (IL)

Correspondence Address: WELSH & FLAXMAN LLC, 2450 CRYSTAL DRIVE, SUITE 112, ARLINGTON, VA, 22202, US

(21) Appl. No.: 10/497,208

(22) PCT Filed: Nov. 25, 2002
(86) PCT No.: PCT/IL02/00940

(30) Foreign Application Priority Data
Dec. 2, 2001 (IL) 146860

(51) Int. Cl. B62M 1/00

(52) U.S. Cl. 280/221

(57) ABSTRACT

A self driven device in which a front and a rear wheel are connected by a stretching member that biases the wheels to a contracted state. A cyclic action of the rider expands the distance between the wheels which are allowed forward rotation by at least one ratchet gear. In some embodiments the hands as well as the feet and bodyweight are used to power the self-riding device. A stabilization mechanism is implemented in some embodiments balancing is implemented to keep the driven device parallel to the ground.

### FIELD OF THE INVENTION

The present invention relates to self driven mobile devices, or, more particularly, to roller skates, roller skis, cycles, and the like, powered by human muscular force.

### BACKGROUND OF THE INVENTION

Disclosed in U.S. Pat. Nos. 4,396,204 and 5,492,345 is a self driven mobile device. According to these patents, the roller skates comprise a base, a front roller and a rear roller set on the base, a reversible drum connected with the drive roller by means of a ratchet gear, a spring-loaded flexible cord with one of its ends wound round the drum and the other end connected with a pivoting foot support operative for rotation of the drum, and, respectively, the drive roller.

While skating the skater shifts his body weight from one foot onto the other thereby causing the pivoting foot support to pull and release the cord alternately. While pulled on, the flexible cord turns the drum which, through the ratchet gear engaged with the roller, transfers the rotation onto the latter. When released, the cord turns the drum in the other direction with the help of the spring. At the same time, the ratchet gear disengages the drum and the roller.

The main drawback of these roller skates is the relatively small travel of the pedal, and, consequently, the small angle of turn of the drum when it is driving the wheels. Therefore, this device is rather inefficient since the transferred energy is small and the possibility of its increase by increasing power (also, by using various transmissions) is confined within the limits of human abilities.

### SUMMARY OF THE INVENTION

The object of the present invention is increasing the efficiency of self driven mobile devices by means of increasing the transferred energy with input power within the limits of human abilities.

Another object of the invention is extending the field of application of occupant driven mobile devices and broadening the scope of functional resources of these devices without complicating the design thereof.

These and other objects are fulfilled due to the circumstance that the mobile device comprises a front wheel assembly and a rear wheel assembly connected to the base and being displaceable with regard to each other. In the initial position the wheel assemblies are set at a fixed distance from each other, at least one of them being the drive wheel assembly. A drive wheel typically has a reversible drum connected thereto by means of a ratchet gear. The two wheels assemblies are connected to each other by a flexible member having one of its ends secured on a drum and wound round it. A spring biases such wheel to wind the flexible member round the drum.

In the majority of embodiments of the present invention the mobile device comprises a means of moving the wheels apart operated by human muscular force.

The present invention will be understood more fully from the detailed description given hereinbelow and from the accompanying drawings, which, however, should not be taken to be limitative to the invention but are for explanation and understanding only.

### BRIEF DESCRIPTION OF THE DRAWINGS

The main features of the present invention are disclosed in connection with the drawings which are as follows:

FIG. 1 is a schematic description of a construction made in accordance with an embodiment of a self driven device of the invention;

FIG. 2A is a schematic description of an embodiment of the invention according to the present invention with a low center of gravity;

FIG. 2B is a schematic description of the embodiment of FIG. 2A with the balancing system shown;

FIG. 3 is a schematic description of a wheel drum assembly of an embodiment of the invention;

FIG. 4 is a schematic description of a hand and foot driven embodiment of the invention;

FIG. 6—is a schematic description of an embodiment implementing coordinated balancing.

### DETAILED DESCRIPTION OF THE PREFERRED EMBODIMENTS OF THE PRESENT INVENTION

In accordance with the present invention a rider drives one or two mobile devices by applying force and/or bodyweight. The force and body weight drive one or two wheel-assemblies at least one of which contain a unidirectional gear. The wheel-assembly containing a unidirectional gear is a drive wheel-assembly.

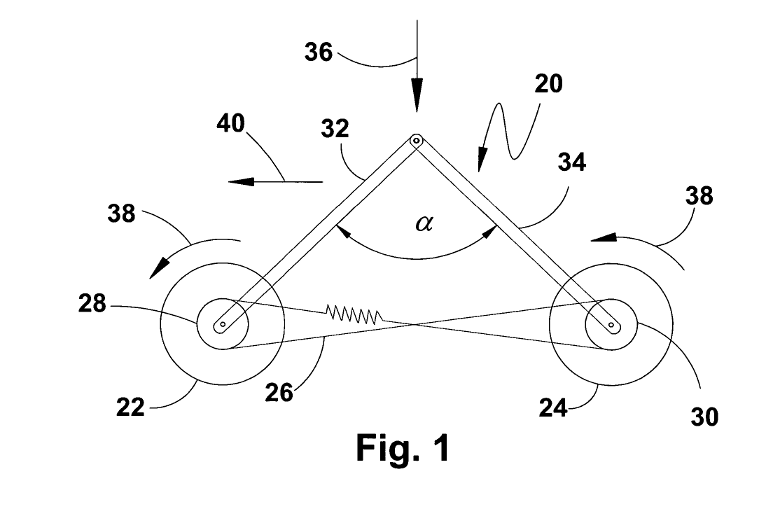

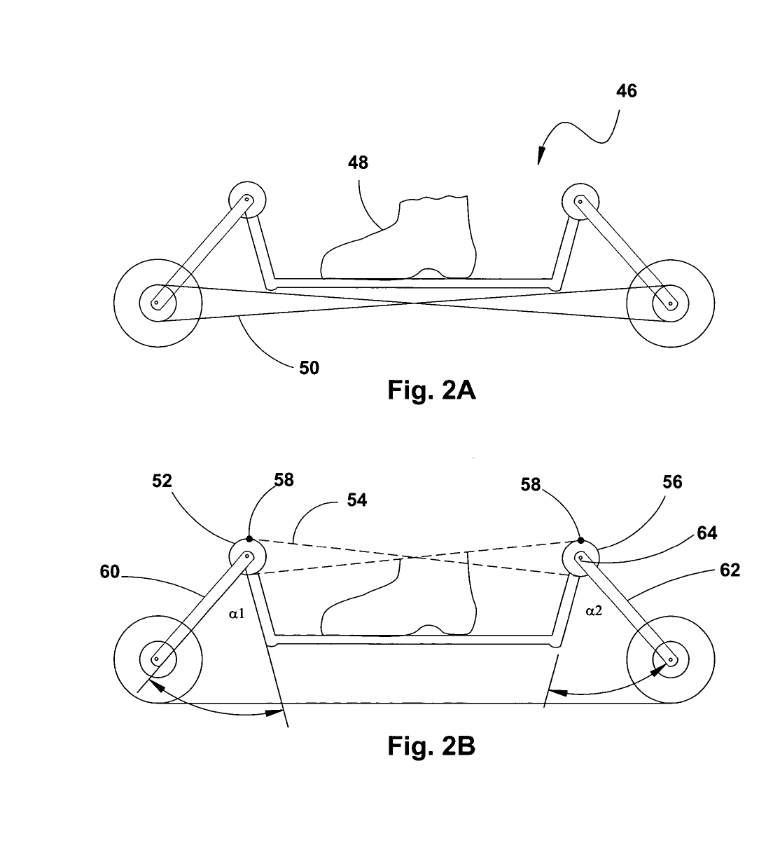

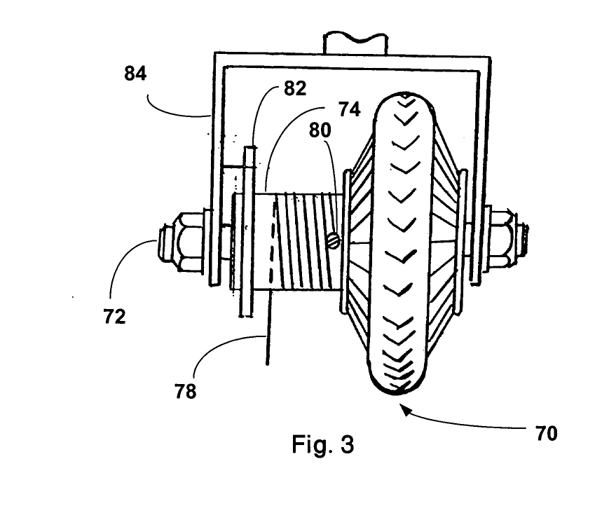

In accordance with an embodiment of the present invention, a forward or a side motion is generated by the cyclic action of the body of the rider, whereby one or two separate carts are employed, accepting the force applied by the two feet, alternately. The rider applies force typically by pressing a foot and body weight on a foothold, in a cyclic motion alternating with the other foot. An embodiment of the present invention is illustrated in FIGS. 1 and 2 to which reference is now made. The mobile device 20, illustrated in FIG. 1 comprises a front wheel 22, a rear wheel 24, and a stretching member 26. The stretching member 26 encircles front and rear stretching wheels 28 and 30, respectively. Front wheel 22 has a common pivot with front support bar 32 and rear wheel 24 has a pivot in common with rear support bar 34. A ratchet gear (not shown) is associated with the pivot of front wheel 22 and another one with the pivot of rear wheel 24. Functionally, the cyclic powering of the mobile device in the direction of arrow 36 causes corresponding increases and decreases in the apical angle α formed between the support bars 32 and 34, thereby causing displacement of the whelks relative to one another. The ratchet gears permit cyclic motion of the wheels in direction of arrows 38. Mobile device 20 therefore moves in the direction of arrow 40.

In FIGS. 2A and 2B to which reference is now made, another embodiment of the invention is described, and another aspect of the invention is disclosed. In FIG. 2A a driven device 46 is powered by a single foot 48 pressing down cyclically, typically by shifting the weight of the body to a side. A in the embodiment described above the driven device moves forwards by the action of the foot, further cyclic motion being maintained by the action of the stretching member 50. In FIG. 2B an angle balancing device is described, and for the sake of clarity, the stretching member is not drawn. Front balancing pulley 52 is connected by rigid member 54 wrapped around the front pulley and the rear pulley 56. Alternatively the rigid member is made not as a continuous wire but as two piece connector. In any case, the rigid member is fixed to each pulley in a fixing point 58. When front wheel support 60 moves forwards, the from pulley turns on a common pivot pulling the rigid member forwards which pulls point 58 on pulley 56 forwards. As a result of this pull, the rear wheel support 62, rotatable around pivot 64 is urged backwards. In more general terms, the angles α1 and α2 are kept equal, meaning that the driven device is kept substantially parallel with the ground. This property helps stabilize the driver driving the device. In both embodiment described above, the flexible member is typically a linear spring supported by cords on both sides. The invention can be implemented using spiral springs and cord as a flexible member.

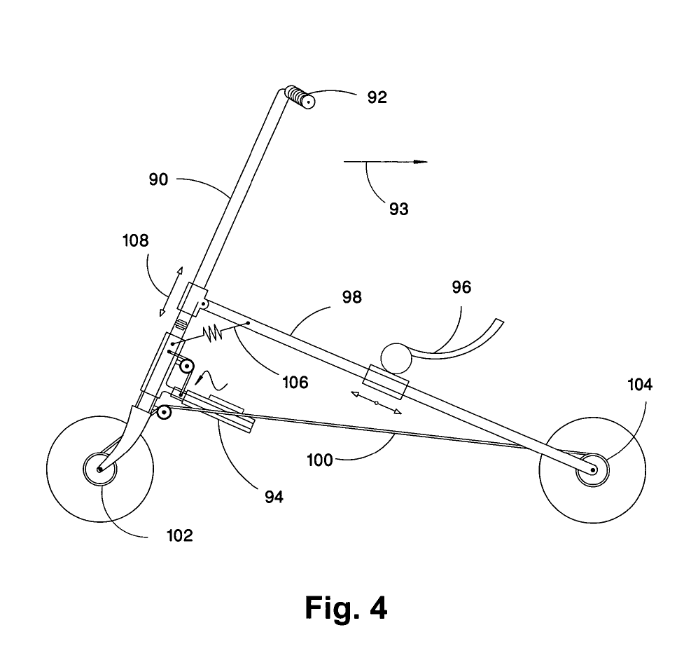

Reference is now made to FIG. 3 which describes a kinematic mechanism comprising a wheel and drum assembly, implemented in some embodiments of the invention. Wheel 70, seen from above, revolves around axis 72, as does drum 74. Around drum 74 is shown wound cord 78. The cord is tied to the drum at tie point 80. The wheel revolves unidirectionally, the revolution being restricted by a ratchet and pawl bearing (not shown). The drum however is revolvable when the wheel stops revolving. Winding the cord on the drum is provided by the biasing of a spiral spring 82. The spiral spring is tied at one end to the drum 74 and at the other end to the frame 84.

The present invention extends the realm of self driven mobile devices. First of all, it is due to the fact that the kinematic mechanisms serving as the means of moving the wheel-assemblies separately may be arranged in an unlimited variety of ways. They may be shaped and sized like various mobile devices, they may comprise parts thereof, etc. Besides, it may be designed so as to ensure involvement of preset most efficient groups of muscles in driving the device.

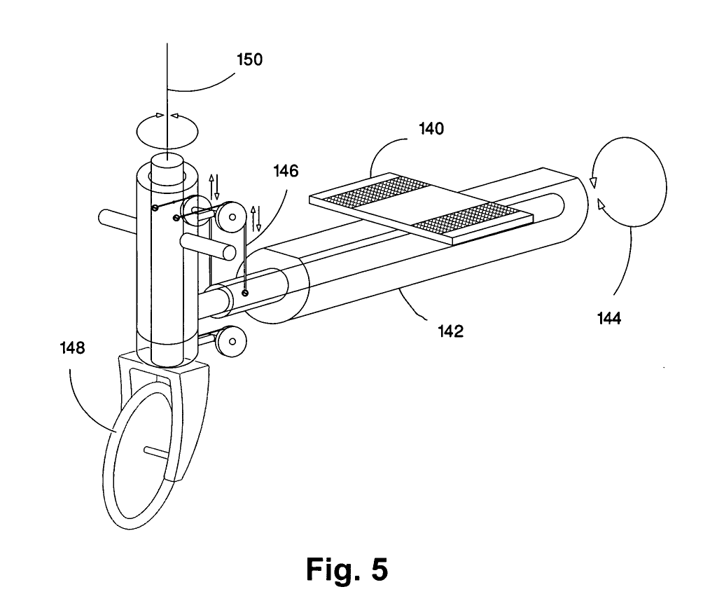

For example, both arms and legs can take part in driving the self driven device of the invention. In FIG. 4 a bicycle is shown wherein bar 90 of is made integral with handle-bar 92. Bar 90 has foot supports 94 attached thereto. Seat 96 is provided with its front portion connected to bar 98 by a hinge. Cord (stretching member) 100 is windable round drums 102 and 104. Functionally, the bicycle is powered by the pulling action of the handle bar 92 in the direction of arrow 93. The bicycle is operated by alternate pulling on the handle-bar 92 with muscular force and its subsequent release. Upon application of pulling force, cord 100, against the resistance of spiral springs, unwinding drums 102 and 104 engaged with front and rear wheels, respectively. The mobile device moves in the direction opposite to the pulling force, indicated by arrow 93. Cord 100, upon cessation of the pulling, pulled on by one or two spiral springs, winds around drums 102 and 104 causing them to rotate in the direction opposite to that of the forward driving wheel direction. As long as the drums, while rotating in this latter direction, do not engage with their respective wheels, the mobile device continues moving by inertia forwards. The subsequent periodic applications of force ensures the continuous motion of the device. Ratchet gears on at least one wheel, promote unidirectional movement. When the handle bar is pushed forward the distance between the wheels is contracted, and the cord 100 is wound around at least one drum, as explained above. Another cord 106 in another embodiment is added. The seat 96 is shiftable along bar 98 to fit riders dimensions. The contact point of bar 98 is shiftale on bar 90 as indicated bay arrow 108 to regulate the torque produced by the pulling force.

Another embodiment of the invention incorporates a steering mechanism. In FIG. 5 to which reference is now made, the foot support 140 rests on a bar 142 tiltable sideways in the direction of arrow 144. Cord 146 transduces the foot tilting into changing the direction of front wheel 148, around axis 150.

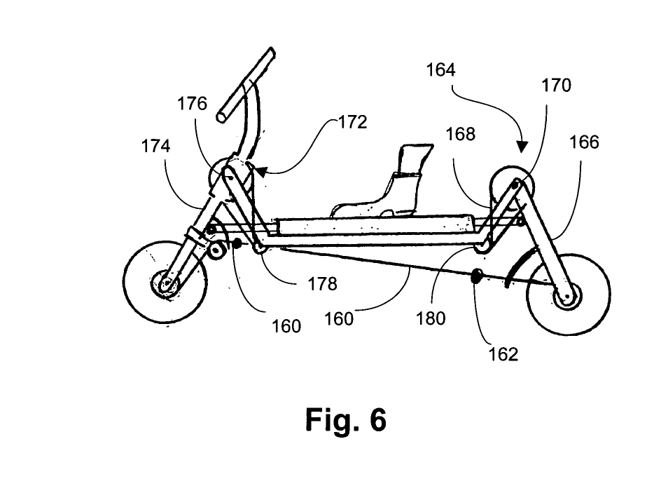

Another aspect of the invention is disclosed in reference to FIG. 6. The cart in this embodiment comprises a coordinated balancing mechanism that ensures that the cart, while being cyclically lowered and elevated, in the course of active riding by the occupant-rider, does not incline either at the front or at the back end. Such inclination can come about as a result of uneven distribution of ground friction, causing front wheel assembly to achieve a different path as compared to the rear wheel-assembly. To curb such an undesirable inclination, several components are incorporated into a cart of the invention cord limiters 160 and 162 prevent excessive winding up of cord on the front and rear drums, respectively. Moreover, rear balancing wheel 164, attached to rear bar 166, is wrapped by cord 168, being also tied to it. When the 166 changes the angle of inclination around pivot 170, wheel 164 synchronized with bar 166 around pivot 170, turns the cord 168 in the direction of rotation. coordination cord 168, being a complete loop, is also wrapped around wheel 172, tied to it and turns with it simultaneously. Wheel 172 is connected with bar 174 so that their rotation around pivot 176 is synchronous. By arranging the loop of cord 168 in a cross, the right turn of wheel 164 brings about an opposite turn, i.e. a left rotation of wheel 172. In order to keep the coordination cord clear of the active feet, a series of pulleys is used, such as pulley 178 and 180.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

1. A self driven mobile device comprising:
two wheel-assemblies, displaceable with regard to each other, at least one of them being a drive wheel assembly,
a unidirectional gear associated with at least one of said wheel-assemblies, and
a flexible member connecting the two wheel-assemblies, wherein said flexible means biases the wheel-assemblies towards each other.

2. The mobile device according to claim 1, furthermore comprising a means of moving the wheels apart operated by human muscular force.

3. The mobile device according to claim 1, wherein at least one wheel-assembly thereof contains two parallel wheels.

4. The mobile device according to claim 1, wherein the means of moving the wheel-assemblies apart comprises a kinematic mechanism further comprising a first member having its separate section connected to the first wheel, and a second member having its separate section connected with the second wheel, the said first member and second member being connected to each other in such a manner that the distance between said sections thereof is varied in the course of functioning of the device.

5. The mobile device according to any of claims 1, wherein the said flexible member is a spring containing member.

6. The mobile device according to any of claim 1, wherein the both wheel-assemblies are drive wheels assemblies.

7. The mobile device according to any of claims 1, wherein the said flexible member is a cord member connected to spiral spring windable around a drum of at least one wheel-assembly.

8. The mobile device according to any of claim 5 and wherein at least one end of the flexible member is wound round drums of the both wheel-assembly in such directions that when the wheels are being moved apart the drums ensure their rotation in the same direction.

9. A self driven mobile device as in claim 1 further comprising a balancing mechanism.

10. An occupant driven mobile device as in claim 1 further comprising a steering mechanism operated by a foot tilting operation.
